(19) United States
(12) Patent Application Publication
(10) Pub. No.: US 2009/0000865 A1
(43) Pub. Date: Jan. 1, 2009

(54) Soundproofing Coatings, Method for the Production Thereof and Use of the Same

(75) Inventors: Peter Zisch, Munchen (DE); Peter Merz, Wollerau (CH); Norman Blank, Ruschlikon (CH)

Correspondence Address: HODGSON RUSS LLP;THE GUARANTY BUILDING, 140 PEARL STREET, SUITE 100, BUFFALO, NY, 14202-4040, US

(73) Assignees: BMW AG, Munich (DE); SIKA TECHNOLOGY AG, BAAR (CH)

(21) Appl. No.: 10/569,533

(22) PCT Filed: Aug. 24, 2004
(86) PCT No.: PCT/EP04/09449

§ 371 Date: Feb. 20, 2007

(30) Foreign Application Priority Data
Aug. 29, 2003 (DE) 103 40 011.7

(51) Int. Cl. G10K 11/168; B05D 3/02

(52) U.S. Cl. 181/290; 427/372.2

(57) ABSTRACT

The invention relates to a sound-absorbing coating for an elastic structure (1) made of at least two polymers, comprising at least one coating layer (2) closer to the elastic structure (1) and made of at least one polymer A and at least one coating layer (3) farther from the elastic structure (1) and made of at least one polymer B, the latter coating layer (3) being applied immediately on said at least one polymer A so as to form an integral composite effecting a loss factor in the range of from 0.01 to 0.6 in a temperature range of from −20° C. to +80° C. The invention also relates to a process for preparing such a coating and the use of such a coating for making sound-absorbing coatings, for example on automotive vehicles.

The present invention relates to sound-absorbing coatings, particularly to sound-absorbing coatings for elastic structures as, for example, machine housings, metal plates for automotive vehicle bodywork, and relates to processes for preparing such coatings. The invention also relates to the use of sound-absorbing coatings.

Elastic structures as, for example, partial structures of tools or their housings, machines and their housings, housings of devices having moving technical parts (engines, transformers, etc.), structures of automotive vehicles (automotive vehicle bodywork surfaces, sound-absorbing walls etc.) are exposed to vibrations and/or emit sound due to the influence of structure-born sound and/or due to the stimulation by sound transmitted via the air. It was proposed a long time ago and, hence, is already prior art to provide such elastic structures with a sound-absorbing coating layer. Such coating layers may consist of one layer of a homogeneous or heterogeneous material or of a plurality of layers comprising the same or different material(s). The layers are applied by placing or adhering or adding, by filling, such layers, or by applying a layer composite or by spraying one or several material(s), singly, successively or together onto or to the structure to be provided with a sound-absorbing structure. The basic procedure, when applying such sound-absorbing coatings on body parts of vehicles is described, for example, in the document “K. M. Lilley, M. J. Fasse and P. E. Weber; A Comparison of NVH Treatments for Vehicle Floorpan Applications; 2001-01-1464, The Society of Automotive Engineers, Inc.” and, in addition, in a large number of other documents.

The document U.S. Pat. No. 3,833,404 describes a sound-absorbing means for a part exposed to vibrations, said means comprising an inner layer of a visco-elastic material to be applied to the surface exposed to vibrations and adhered thereto, and a rigid outer plastic layer, which is applied to the visco-elastic material and adhered thereto. The visco-elastic material consists of a composition of a mutually inter-penetrating polymer network in the form of a polymer mixture comprising 5 to 95% by weight of a reticulated polymeric material and 95 to 5% by weight of a reticulated elastomer, wherein the polymer networks are reticulated substantially independently. The coating layers are made by first preparing a first polymer, preferably in the form of a latex, and incorporating a monomer for the second polymer, then polymerizing the monomer to the second polymer in situ, applying the latex (optionally enriched by further components) onto the surface to be provided with the sound-absorbing layer by commonly usual processes and applying the rigid outer layer onto the composite so as to provide an integral coating layer material.

The document DE-B 28 52 828 discloses a process for preparing layers made of per se known materials for obtaining an absorption of body sound, preferably by applying the materials by spraying. According to this document, two coating materials having different elasticity moduli are applied successively onto the surface to be provided with the sound-absorbing coating by spraying, whereby the elasticity moduli of the two materials have values in a certain relative difference; particularly, the elasticity modulus of the outer material applied as the second is higher than that one of the inner material applied as the first by a factor of 40 to 1000.

Moreover, multilayer sound-absorbing films for the purpose of improving the sound absorption in automotive vehicles became known from the prior art, which films consist of a layer of butyl rubber and of a thin outer aluminum top layer applied by lamination. The aluminum top layer preferably has a thickness of about 0.1 mm and provides a higher rigidity of the composite determined for sound absorption, compared to coating layer materials known from the prior art.

However, a disadvantage of the materials for improving sound absorption known up to now is that extraordinarily high costs are caused by their production and application onto surfaces to be provided with an improved sound absorption. For that reason alone, a remedy was desired. Moreover, certain areas of a vehicle body having complicated metal sheet geometries could not be provided neatly in an automated process with such multi-layer sound-absorbing coatings including an aluminum top layer; such applications required a careful manual touch-up, making the practical operation of the application of a sound-absorbing material more difficult.

Furthermore, the materials known up to now did not maintain their mechanical and sound-absorbing properties when exposed to the temperatures required for modern devices, particularly modern automotive vehicles, i.e. to temperatures in the range between −20° C. and +80° C. Hence, sound-absorbing materials having a novel composition and being suitable for novel, economical application processes had to be provided, which materials, in addition, have improved and stable sound-absorbing properties throughout the whole temperature range of from −20° C. to +80° C.

Hence, it was an object of the present invention to remedy the disadvantages of the prior art and to develop materials suitable for sound absorption which may be processed in a convenient and cost-saving way in automated processes usually applied in mechanical engineering and, particularly, in the technology of manufacturing vehicles nowadays. It was another object of the invention to achieve that sound-absorbing coatings having low weights per area unit and applied by such processes result into a good sound absorption. Furthermore, it was an object of the invention to develop such materials showing such improved properties in a stable manner throughout temperature ranges larger nowadays, compared to former times and, particularly, maintaining a good sound absorption over the whole temperature range of from −20° C. to +80° C.

It was now surprisingly found that a multilayer construction comprising at least two different polymers which result into differently rigid polymer layers but, when included into a composite, show an improved sound absorption, are suitable for a rapid application onto surfaces to be subjected to a sound absorption, for example onto a machine housing or to an automotive vehicle and, in particular, to a vehicle body.

Hence, the invention relates to a sound-absorbing coating for an elastic structure made of at least two polymers, comprising at least one coating layer closer to the elastic structure and made of at least one polymer A and at least one coating layer farther from the elastic structure and made of at least one polymer B, the latter coating layer being applied immediately on said at least one polymer A so as to form an integral composite effecting a loss factor in the range of from 0.01 to 0.6 in a temperature range of from −20° C. to +80° C.

The invention also relates to a process for the application of a sound-absorbing coating as described below in detail onto an elastic structure, said process comprising the steps of
optionally providing the elastic structure with a base coat;
applying at least one coating layer made of at least one polymer A on said optionally provided base coat or on the elastic structure;
optionally curing said coating layer(s) thus applied completely or in part;
applying at least one coating layer made of at least one polymer B on said layer(s) thus applied and optionally cured at least in part; and
completely curing said layer(s) thus applied.

The invention also relates to the use of a coating according to the subsequent detailed description for forming a sound-absorbing coating on partial structures of tools or their housings, on machines and their housings, on housings of devices having moving mechanical parts or on structures of automotive vehicles.

The invention is described further in detail below by referring to the accompanying drawings and the detailed description below.

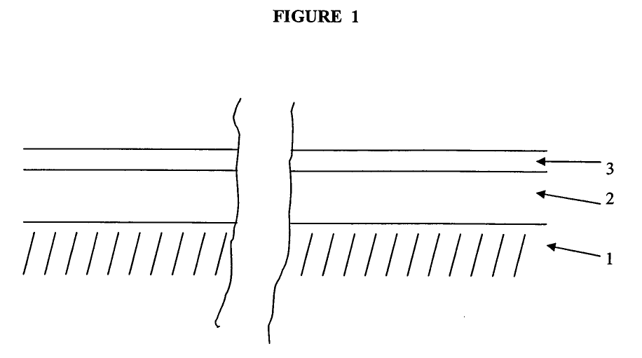

FIG. 1 shows a preferred structure of a sound-absorbing coating according to the invention.

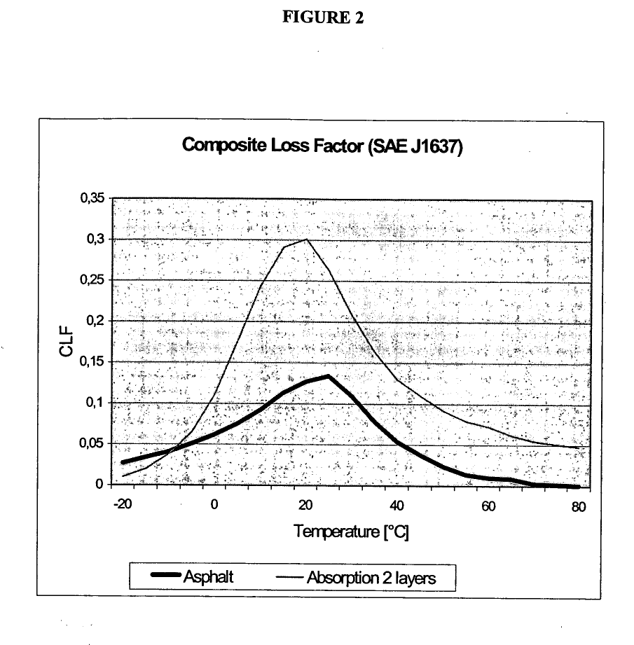

FIG. 2 shows a graphical representation of the measurement of the loss factor of a sound-absorbing coating according to the invention and of one according to the prior art throughout the temperature range of from −20° C. to +80° C.

Any subsequent reference to the Figures and to the preferred embodiments given in the description should not be understood to limit the invention, but serve to exemplarily illustrate the invention only.

The term “elastic structures 1” as referred to in the frame of the present invention is understood to substantially mean two-dimensional structures having a certain elasticity due to their structure, which elasticity allows to at least partially give up the shape as a result of, for example, a mechanical influence, but to return more or less to the original shape upon termination of said mechanical influence. Such an “elastic” behavior may also be observed on elastic structures as a result of a stimulation by sound transmitted by the air or of the influence of structure-borne sound: Elastic structures show a stimulation upon the influence of such sound events which are perceived in the form of low-frequency noise which is felt to be very unpleasant. Typical examples of elastic structures, in the frame of the present invention, are e.g. certain structures of tools or of their housings, of machines and their housings, for example compressor housings or pump housings, structural body parts of automotive vehicles as, for example, the engine bonnet or the wall between the engine compartment and the passenger compartment etc. Such structures may be metal sheets, polymer layers or polymer sheets or composites of several metal sheets, of polymer layers or of one or several metal sheet(s) and of one or several polymer layer(s).

Surprisingly, the sound absorption of such elastic structures 1 could be achieved by using the sound-absorbing coating for an elastic structure 1 according to the invention. The sound-absorbing coating, in the frame of the pre-sent invention, comprises at least two polymers. In accordance with the invention, the coating comprises at least one coating layer 2 closer to the elastic structure 1 and made of at least one polymer A and at least one coating layer 3 farther from the elastic structure 1 and made of at least one polymer B and being applied immediately to at least one polymer A while forming an integral composite on the elastic structure. In accordance with the invention, the sound-absorbing coating produces a loss factor in the range of from 0.01 to 0.6, within a temperature range of from −20° C. to +80° C., on the elastic structure.

The loss factor obtainable with the sound-absorbing coating according to the present invention is defined here—as also in the present field of the art—and is determined in a way described in the document “K. M. Liley et al.; loc. cit.”.

The sound-absorbing coating in accordance with the present invention comprises at least two layers made of polymer material. The invention, however, is not restricted thereto. The number of layers may be higher and, for example, may be three or four. Particularly preferred, however, are sound-absorbing coatings for an elastic structure comprising two layers of polymeric material. Of those layers, one coating layer 2 is arranged closer to the elastic structure 1, i.e. closer, for example, to the metal sheet or to the polymer layer, while the other coating layer 3 is farther or more remote from the elastic structure 1 and, in accordance with the invention, is applied immediately on at least one polymer of the coating layer 2 located closer to the elastic structure 1.

In a particularly preferred embodiment of the invention, the sound-absorbing coating according to the invention comprises two polymers A and B applied onto the elastic structure in the form of an integral composite. This is advantageous due to the fact that a considerably better sound absorption may be achieved than with coatings consisting of only one layer. However, by using the coatings of the present invention, an improved sound absorption can be achieved also in comparison to the two-layer coatings described in the document DE-B 28 52 828: The improvement is shown by the loss factor achieved, which may be better than 0.3 in accordance with the present invention, what may be achieved surprisingly by using a coating of the present invention having a weight per area unit considerably lower than that of the coatings of the prior art. This is of particular advantage for the manufacture of automotive vehicles, since there are numerous attempts to save weight wherever possible in order to achieve favorable ratios of engine power to vehicle weight.

As already noted above, the two coating layers 2 and 3 may consist of one single coating layer each (i.e. one coating layer 2 and one coating layer 3), or they may consist of plural layers each (i.e. layers 2′, 2″, 2′″ and layers 3′, 3″, 3′″). Preferred is a structure of two single coating layers 2 and 3.

Each of these coating layers may consist of a single polymer material, wherein the coating layer 2 is made, according to the definition, of the polymer material A and the coating layer 3 is made of the polymer material B. However, this is not compulsory. In accordance with the invention, it is possible that one of the coating layers 2 or 3, or both coating layers 2 and 3 each for itself is made of several polymer materials, for example of two or three polymer materials which are usually present in the form of a polymer mixture (“blend”). It is not necessary that the distinguishing features of the polymer materials of the respective layer 2 and/or 3 consist in that two or more different polymer materials are included in the term of a “blend”; it may be that the distinguishing feature of the material(s) of one or both of the layers 2 and 3 is that the polymerization degree of one or of several of the polymers and/or the degree of reticulation and/or any other relevant property, particularly any property relevant for the sound absorption, of one or of several of the polymers within one layer is different, i.e. that the layer shows a gradient in relation to the respective property. This is not compulsory for achieving the valuable properties according to the invention, but it may be preferred in a single case.

The polymer or the polymers A for the coating layer 2 and the polymer or the polymers B for the coating layer 3 may be selected from a large number of polymers. For selecting the polymers, the only decisive feature is the loss factor of the coating for the sound absorption which may be achieved with the sound-absorbing coating according to the invention.

In a preferred but nevertheless not restricting embodiment of the invention, the sound-absorbing coating according to the invention comprises, as the at least one polymer A, a polymer selected from the group consisting of the following polymers: homopolymers, copolymers and blends of homopolymers and copolymers of acrylic acid, of methacrylic acid, of acrylic acid alkyl esters (for example, but not restricted to methyl acrylate, ethyl acrylate, n-propyl acrylate, i-propyl acrylate, n-butyl acrylate, i-butyl acrylate, sec-butyl acrylate, tert-butyl acrylate), of methacrylic acid alkyl esters (for example, but not restricted to methyl methacrylate, ethyl methacrylate, n-propyl methacrylate, i-propyl methacrylate, n-butyl methacrylate, i-butyl methacrylate, sec-butyl methacrylate, tert-butyl methacrylate), of acrylonitrile, of methacrylonitrile, of vinyl compounds (for example, but not restricted to vinyl alcohol, vinyl acetate, vinyl chloride, styrene, α-methyl styrene, vinylidene chloride), of polyvalent diols and higher isocyanates (polyurethanes), of straight chain and branched alkenes, particularly of straight chain lower (i.e. having 1 to 6 carbon atoms) α-olefins (for example, but not restricted to ethylene, propylene, 1-butene) and 1,3-dienes (for example, but not restricted to butadiene, isoprene), natural rubbers and synthetic rubbers (for example, but not restricted to natural rubber, polybutadiene, butyl rubber, isoprene rubber, chloroprene rubber, Thiokol^{R} rubber, ethylene propylene diene (e.g. butadiene) terpolymers, (meth-) acryl diene (e.g. butadiene) vinyl (e.g. styrene) terpolymers. There may be used one of the above-mentioned polymers, or there may be used several of the above-mentioned polymers.

In a further preferred embodiment of the invention, the sound-absorbing coating according to the invention comprises, as the at least one polymer B, a polymer selected from the group consisting of the following polymers: homopolymers, copolymers and blends of homopolymers and copolymers of acrylic acid, of methacrylic acid, of acrylic acid alkyl esters (for example, but not restricted to methyl acrylate, ethyl acrylate, n-propyl acrylate, i-propyl acrylate, n-butyl acrylate, i-butyl acrylate, sec-butyl acrylate, tert-butyl acrylate), of methacrylic acid alkyl esters (for example, but not restricted to methyl methacrylate, ethyl methacrylate, n-propyl methacrylate, i-propyl methacrylate, n-butyl methacrylate, i-butyl methacrylate, sec-butyl methacrylate, tert-butyl methacrylate), of acrylonitrile, of methacrylonitrile, of vinyl compounds (for example, but not restricted to vinyl alcohol, vinyl acetate, vinyl chloride, styrene, α-methyl styrene, vinylidene chloride), of polyvalent diols or glycidyl ethers and higher isocyanates (polyurethanes), of straight chain and branched alkenes, particularly of straight chain lower (i.e. having 1 to 6 carbon atoms) α-olefins (for example, but not restricted to ethylene, propylene, 1-butene) and 1,3-dienes (for example, but not restricted to butadiene, isoprene), of compounds to which epoxy group containing compounds may be added (epoxy resins), of phenylene oxide, of carbonates (polycarbonates), of di- or polycarboxylic acids and diamines/imines (polycarboxylic acid amides/imides), of sulfones (polysulfones), of di- or polycarboxylic acids and di- or polyoles (polyesters), of halogenated, particularly of fluorinated compounds (for example, but not restricted to tetrafluoro ethylene and other completely or partly fluorinated hydrocarbons) as well as phenol-formaldehyde condensation products, polyacetales, phenol resins, amine resins (for example, but not restricted to melamine resins, urea resins, urethane resins).

Among the above-mentioned polymers, as the polymer A for the coating layer 2, the following polymers are particularly preferred: homopolymers, copolymers and/or blends of homopolymers and/or copolymers of acrylic acid, methacrylic acid, alkyl esters of acrylic acid and alkyl esters of methacrylic acid, as well as rubbers or their blends with each other and with the other polymers mentioned above. Moreover, among the above-mentioned polymers, as the polymer B for the coating layer 3, there are particularly preferred epoxy resins, amine resins (particularly melamine resins and/or urethane resins) and their blends. Particularly advantageously, for example the product SikaDamp^{R} 630 (SIKA AG, Zürich, Switzerland) is used as the polymer A, said product being a rubber, [e.g. a butyl rubber] containing one or several fillers (as, for example, carbonate(s) [e.g. calcium carbonate] and/or oxide(s) [e.g. titanium oxide, silicon oxide]) as well as a plasticizer, an adhesive and additional additives; and/or the product SikaPower^{R} 430 (SIKA AG, Zurich, Switzerland) is used as the polymer B, said product being a blend of epoxy resins and polyurethane resins, optionally including additives. In an integral composite, the application of both polymers onto the elastic structure results into a surprisingly superior sound absorption throughout the whole temperature range of from −20° C. to +80° C., and the polymers may be applied easily onto elastic structures 1 as, for example, metal sheets or plastic polymer structures in automated processes, for example by spraying, depositing, applying by means of a slot die, applying by extruding or similar, per se known processes, what was particularly desired in the field of manufacturing automotive vehicles.

In a further embodiment preferred in accordance with the invention, at least one of the polymers B of the coating layer 3, advantageously the polymer B of the coating layer 3, is a reticulated polymer. The term “reticulated polymer”, as used herein is considered to mean one or several polymer(s) having, in addition to the covalent bond between the monomer building blocks in the main chain, at least one further covalent or ionic or other bond from one monomer building block to at least one further monomer building block. Typical examples of polymers B of the coating layer 3 effecting a reticulation of the polymer are phenol-formaldehyde resins and polyurethane resins. It is also conceivable that the polymer B of the coating layer 3 contains a reticulating component which is different from the specific monomer building block and has the capability to effect a reticulation of the chain made of monomer building blocks. Examples for such reticulating components may be organic components or inorganic components.

Examples for an organic reticulating component are compounds containing several active groups as, for example, reactive aldehydes (formaldehyde, glutardialdehyde), divinyl benzene, tetraethylene glycol dimethacrylate or diamines; an example for an inorganic reticulating component is sulfur.

Moreover, it is a preferred embodiment of the sound-absorbing coating for an elastic structure in accordance with the present invention that the elasticity modulus of at least one of the polymers B after curing is larger than the elasticity modulus of at least one of the polymers A. More preferably, the elasticity modulus of the polymer B farthest from the elastic structure 1 or—in case that only one polymer B is present in the coating layer 3—the elasticity modulus of the polymer B is larger that the elasticity modulus of at least one of the polymers A or—in case that only one polymer A is present in the coating layer 2—than the elasticity modulus of the polymer A. In both cases, the values of the elasticity moduli are the values of the elasticity moduli of the polymers after curing. Even more preferably, the factor by which the elasticity modulus of the at least one polymer B or of the one polymer B is larger than the elasticity modulus of the at least one polymer A or of the one polymer A is smaller than 10, both elasticity modulus values being given as values after curing.

The thickness of the coating layers of the sound-absorbing structure may be selected freely, basically, and are determined in accordance with the requirements of a lowest possible weight or weight by area unit, respectively, and a way of application by an automated process which is as cost-saving as possible. Advantageously, sound-absorbing coatings in accordance with the invention are used whose thickness of the coating layer 2 closer to the elastic structure 1 and made of the at least one polymer A is in a range of from 0.1 to 10 mm, even more preferred in a range of from 0.5 to 5 mm. In accordance with another preferred embodiment of the invention, the thickness of the coating layer 3 applied onto the coating layer made of the at least one polymer A and made of the at least one polymer B is in a range of from 0.01 to 3 mm, preferably in a range of from 0.01 to 1 mm. When realizing such a structure wherein the thickness of the coating layer 2 closer to the elastic structure 1 is larger than the thickness of the coating layer 3 farther from the elastic structure, excellent values of the sound absorption may be obtained surprisingly. Moreover, such a coating layer structure may be applied easily onto the elastic structure by automated processes, for example by a spaying process best suitable for such purposes or by a process of applying such layers by means of a slot die so as to generate an integral composite made of at least two coating layers while simultaneously securing a cost-saving manufacturing process of the sound-absorbing coating according to the invention.

In a particularly preferred embodiment of the invention resulting into superior results of the sound absorption, the sound-absorbing coating according to the invention comprises a coating layer made of a polymer A selected from the group of acryl polymers as the coating layer 2 closer to the elastic structure 1, more preferably a coating layer 2 made of polybutyl methacrylate or of a butyl rubber, and/or comprises a coating layer made of at least one polymer B selected from the group of epoxy resins and/or urethane resins as the coating layer 3 farther from the elastic structure 1 and applied immediately onto the polymer A or the polymers A. The latter-mentioned resin preferably comprises a reticulating component, too. Comprised by those preferred embodiments are particularly such sound-absorbing coatings wherein the thickness of the coating layer made of the polymer A is in a range of from 0.5 to 5 mm, and/or the thickness of the coating layer made of the polymer B is in a range of from 0.01 to 1 mm.

It is a further preferred embodiment of the invention that the sound-absorbing coating structure made of the two coating layers 2 and 3 on the elastic structure 1 is manufactured in such a way that, in a system consisting of two components for the manufacture of the polymer A for the coating layer 2, one polymer main component is applied onto the elastic structure 1 together with a suitable hardener and is reacted to a polymer A having an elasticity modulus lower than that of the polymer B; and, subsequently, the same polymer main component, or a different one, is applied together with another hardener and is reacted to a polymer B having an elasticity modulus large in relation to that of the polymer A. In a preferred way, an elastic polymer coating layer A and a rigid polymer coating layer B are generated on the elastic structure 1 (for example on a metal sheet), said polymer layers having excellent sound-absorbing properties. The coating layers can be applied and manipulated easily.

Each of the two layers 2 and 3 may contain further components in addition to the polymers, such components serving special requirements. Such further components are well known as such to a person skilled in this technical field, and they may comprise: fillers (for example, but not restricted to carbon black, fibrous materials as e.g. glass fibers, carbon fibers, etc., inorganic fine particulate materials as e.g. silicon oxides, titanium oxides, aluminum oxides, carbonates), agents for adjusting the viscosity, aging inhibitors, cross-linking agents, etc.

The sound-absorbing coatings of the present invention may contain further coating layers in addition to the coating layers 2 and 3 mentioned above, which additional layers are not decisive for achieving a good sound absorption (for example in the sense of a good loss factor throughout the whole temperature range of from −20° C. to +80° C.), which, however, may contribute thereto and, optionally, may also serve other purposes. Examples of such layers may be: a base layer which is applied preferably directly onto the elastic structure 1 and may serve to improve the adhesion to the elastic structure or protect the latter from corrosion; a protective layer, which is applied preferably farthest from the elastic structure, for example onto the coating layer 3 made of at least one polymer B and which may serve the purpose of protecting against corrosion; an undercoating varnish layer and/or a varnish layer, an oil application layer etc.

The sound-absorbing coating having such a structure has the particularly advantageous property of showing excellent properties of sound absorption throughout a substantially broader temperature range than in the prior art. Particularly in the field of manufacturing automotive vehicles, a good sound absorption throughout a wider temperature range than in former times is of great importance due to the considerably higher temperatures achieved with modern engines. Hence, good loss factors throughout the whole temperature range of from −20° C. to +80° C., accompanied by a high mechanical stability, are very important, and the sound-absorbing coatings of the present invention are superior over those of the prior art particularly with respect to these properties.

The sound-absorbing coating in accordance with the above detailed description is deposited or applied to the elastic structure 1 by means of a process comprising, in accordance with the invention, the following steps: In a first step, the elastic structure 1, for example a plastic polymer sheet or a metal sheet, is provided with a base coat optionally, as far as this is advisable or required for an improvement of the adhesion, for the corrosion protection or for other reasons known to a skilled person. In a second step, at least one coating layer 2 made of at least one polymer A is applied onto the base coat layer optionally applied or, if a base coat is not required or is not advisable, directly onto the elastic structure. As already described above, one coating layer 2 may be applied, or several coating layers 2 may be applied. The one coating layer 2 or—in the case of several coating layers 2—the coating layers 2, each per se, may consist of one polymer A or of several different polymers A. There is no need that any difference between the polymers necessarily is a difference of the monomer building blocks making the polymer, but the difference may also be—for two or more than two identical monomer building blocks—the ratio of their relative amount or may also be the polymerization degree and/or the degree of reticulation of the polymer(s) or any one or more of the other property/properties relevant for the absorption of sound.

In the next process step, the polymer(s) A is/are optionally cured completely or in part and is/are thereby prepared for the next process step. This curing step is an optional step which, however, is carried out under usual circumstances. The curing may be a complete curing where the polymer(s) substantially arrive(s) at a stage which is the final stage for the structure of the final sound-absorbing coating. In another embodiment, however, it is also possible that the polymer layer(s) is/are cured only in part or that the monomers, if reactive polymers are included, are reacted only in part, for example just to a stage where the coating layer, after having been cured partly or after having been formed by a reaction of the monomers, is suitable for the application of the second coating layer. This may be decided by a skilled person and may be adjusted, depending upon the polymer(s) used, in each single case without exerting any inventive activity.

The curing step may be carried out on each route known to a person skilled in this field of the art, and is determined, particularly, by the type of the curing medium, the temperature of the object and the time. In a preferred embodiment of the invention, the temperature of the object and the curing time may be dependent upon each other in such a way that the time may be the shorter the higher the temperature of the object is. Suitable are, for example (without restricting the invention by such examples), a curing process in the form of reacting the components involved (as may, for example, occur in self-reacting systems, particularly); by contacting the components involved with the environment (oxygen, humidity of the air etc.); or by applying suitable forms of energy (heat, for example, but without restricting the invention: warm air in a convection oven; infrared radiation; ultraviolet radiation; microwaves). The conditions required have to be adapted broadly in accordance with the components involved but may be determined by a person skilled in the art in accordance with his skill in a few orienting experiments.

In accordance with the invention, in the next process step at least one coating layer 3 made of at least one polymer B is applied onto the coating layer(s) 2 thus applied. As already described above, one coating layer 3 may be applied, or several coating layers 3 may be applied. The one coating layer 3 or—in the case of several coating layers 3—the coating layers 3, each per se, may consist of one polymer B or of several different polymers B. There is no need that any difference between several polymers B necessarily is a difference of the monomer building blocks making the polymer, but the difference may also be—for two or more than two identical monomer building blocks—the ratio of their relative amount or may also be the polymerization degree and/or the degree of reticulation of the polymer(s) B or any one or more of the other property/properties relevant for the absorption of sound.

As soon as the step of application of the polymer(s) B is terminated, the coating layers 2 and 3 thus applied are completely cured, or the polymers are allowed to completely react so that the desired polymer coating layers are formed which have the advantageous sound-absorbing properties within the composite. For curing, the above-mentioned methods may be applied, and the conditions may be established which a skilled person knows on the basis of his skill in this technical field and which he may adjust in the course of only a few orienting experiments. Particularly, the process of curing the polymers is determined by the type of the curing medium, the temperature of the object and the time. In a preferred embodiment of the invention, the temperature of the object and the curing time may be dependent upon each other in such a way that the time may be the shorter the higher the temperature of the object is.

Optionally, further process steps may be added to the process described above. For example, it may be desired that a protective layer is applied onto the coating layer structure thus prepared.

The application of one or several coating layers, particularly of one or several coating layers 2 and/or 3, may be effected by process steps per se known to a person skilled in this technical field. Examples are a step of depositing (in cases of using materials which cannot be applied by spraying or by means of a slot die), a step of applying the coating layers by spraying, rolling, applying by extrusion, dipping or by any combination of two or of several of the above-mentioned methods. In accordance with the invention, it is particularly preferred that at least one of the steps of (optionally) applying a base coat, applying at least one coating layer 2 made of at least one polymer A and applying at least one coating layer 3 made of at least one polymer B is carried out by spraying, for example by means of suitable spraying means known to a skilled person for this purpose or by means of dies, or by the application by means of slot dies. More preferred is an application by spraying by means of an automated spraying device, which method is advantageous, particularly, in the field of manufacturing automotive vehicles, since this way of application is saving many costs and allows to build up a sound-absorbing coating completely and rapidly even if the geometry of the metal sheets is complicated.

In accordance with a further preferred embodiment of the process of the invention, the material of at least one coating layer of the sound-absorbing coating is applied in the form of a solution, emulsion, melt or blend of the monomers comprising the components for forming the coating layer(s). For example, the material is applied by spraying. Even more preferably, the materials of all coating layers of the sound-absorbing coating are applied in the form of solutions, emulsions, melts or blends of the monomers. In cases of applying blends of monomers undergoing a reaction to form (a) polymer(s) in the course of the application or after the application, the blends advantageously contain all components (including a catalyst, a reaction accelerator and/or other essential or desirable components) already when applied, although it is also possible (albeit less preferred) to apply the components required for the polymerization successively.

As also in the case of usual bulk polymerization reactions, the curing or the initiation of the reaction, particularly of the polymerization reaction, is carried out under the influence of usual media. Also in the present invention, these include the application of heat, the irradiation of actinic radiation (UV, light of a certain wavelength etc.), the application of microwaves or the combination of two or more of the above-mentioned methods. Particularly preferred is the application of heat or the irradiation of actinic radiation. The specific method depends upon the polymer or polymers specifically used for one coating layer, upon the (possible) use of radical generators or upon other parameters known to a skilled person for such type of reactions.

Finally, the invention also relates to the use of the coatings described above. The field of application, when forming sound-absorbing structures, extends to all types of structures for which the absorption of sound is required or desired. Non-restricting examples are sound-absorbing structures on partial structures of tools or their housings, machines and their housings, housings of devices having moving mechanical parts or structures of automotive vehicles. A particularly preferable field of application of the invention is the provision of sound-absorbing coatings on structures of automotive vehicles, for example on vehicle body parts and/or on walls serving for sound absorption, for example walls between the engine compartment and the passenger compartment.

The invention is further explained by referring to specific examples without being restricted to the examples only.

### EXAMPLE

General rules for conducting flexure vibration experiments for determining the sound absorption properties may be learnt from the prior art. For example, tests in the field of manufacturing automotive vehicles are conducted in accordance with SEA J 1637, corresponding to DIN EN ISO 6721-3 as well as in accordance with BMW handling rules for tests of sprayable sound absorption masses.

The coating layer structure in accordance with FIG. 1 was prepared from a flexure vibration strip 1 (test and measurement strip for flexure vibration experiments in analogy to DIN EN ISO 6721-3 made of hardened spring steel, bright polish, having the dimensions 300 mm×8 mm×1 mm). A coating layer 2 made of the polymer A (SikaDamp^{R} 630) in a thickness of 3 mm was applied onto the strip. The polymer may be cured at a temperature of the object in the range of from 180° C. to 210° C. for 5 min or at a temperature of the object in the range of from 155° C. to 190° C. for 40 min. Subsequent to curing, a coating layer 3 made of the polymer B (SikaPower^{R} 430) was applied with a slot die in a thickness of 0.5 mm. This was followed by another curing step at a temperature of 130 to 180° C. (temperature of the object) for 10 min or at a temperature of 130 to 160° C. for 25 to 60 min.

For measuring the loss factor in analogy to DIN EN ISO 6721-3, the flexure vibration strip thus coated was mounted to a test equipment in such a way that the free clamping length was 246±0.5 mm. At least two resonance values per structure were measured. The values obtained were interpolated or extrapolated to 140 Hz and mean values were determined arithmetically for the measured temperatures in the range between −20° C. and +80° C. The values measured may be learnt from the subsequent table. The values are also shown in the graphical representation of the loss factor vs. the temperature in FIG. 2.

As a comparison, a structure according to the prior art was subjected to measurement in the same way as described above. The sound-absorbing coating applied to the flexure vibration strip consisted of an asphalt coating having a thickness of 5 mm.

TABLE
Measurement of the loss factor η

| Temperature (° C.) | Example | Comparative example |
|---|---|---|
| −20 | 0.01 | 0.03 |
| 0 | 0.1 | 0.06 |
| 20 | 0.3 | 0.12 |
| 40 | 0.12 | 0.05 |
| 60 | 0.07 | 0.02 |
| 80 | 0.05 | 0 |

1. A sound-absorbing coating for an elastic structure (1) made of at least two polymers, comprising at least one coating layer (2) closer to the elastic structure (1) and made of at least one polymer A and at least one coating layer (3) farther from the elastic structure (1) and made of at least one polymer B, the latter coating layer (3) being applied immediately on said at least one polymer A so as to form an integral composite effecting a loss factor in the range of from 0.01 to 0.6 in a temperature range of from −20° C. to +80° C.

2. The sound-absorbing coating for an elastic structure (1) according to claim 1, comprising two polymers A and B in the form of an integral composite.

3. The sound-absorbing coating for an elastic structure (1) according to claim 1, wherein the thickness of the coating layer (2) closer to the elastic structure (1) and made of at least one polymer A is in a range of from 0.1 to 10 mm, preferably in a range of from 0.5 to 5 mm.

4. The sound-absorbing coating for an elastic structure (1) according to claim 1, wherein the thickness of the coating layer (3) applied to the coating layer of the at least one polymer A and made of the at least one polymer B is in a range of from 0.01 to 3 mm, preferably in a range of from 0.01 to 1 mm.

5. The sound-absorbing coating for an elastic structure (1) according to claim 1, wherein said at least one polymer B is at least one reticulated polymer.

6. The sound-absorbing coating for an elastic structure (1) according to claim 1, wherein the elasticity modulus of at least one of the polymers B, preferably the elasticity modulus of the polymer B farthest from the elastic structure (1), after curing is larger than the elasticity modulus of at least one of the polymers A after curing.

7. The sound-absorbing coating for an elastic structure (1) according to claim 6, wherein the factor by which the elasticity modulus of said at least one polymer B is larger than that of said at least one polymer A, both after curing, is smaller than 10.

8. The sound-absorbing structure for an elastic structure (1) according to claim 1, comprising, as the at least one polymer A, one or more polymer(s) selected from the group consisting of the polymers: homopolymers, copolymers and blends of homopolymers and copolymers of acrylic acid, of methacrylic acid, of acrylic acid alkyl esters, of methacrylic acid alkyl esters, of acrylonitrile, of methacrylonitrile, of vinyl compounds, of polyvalent diols and higher isocyanates (polyurethanes), of straight chain and branched alkenes, particularly of straight chain lower (having 1 to 6 carbon atoms) α-olefins and 1,3-dienes, natural rubbers and synthetic rubbers.

9. The sound-absorbing structure for an elastic structure (1) according to claim 1, comprising, as the at least one polymer B, one or more polymer(s) selected from the group consisting of the following polymers: homopolymers, copolymers and blends of homopolymers and copolymers of acrylic acid, of methacrylic acid, of acrylic acid alkyl esters, of methacrylic acid alkyl esters, of acrylonitrile, of methacrylonitrile, of vinyl compounds, of polyvalent diols and higher isocyanates (polyurethanes), of straight chain and branched alkenes, particularly of straight chain lower (having 1 to 6 carbon atoms) α-olefins and 1,3-dienes, of compounds to which epoxy group-containing compounds may be added (epoxy resins), of phenylene oxide, of carbonates (polycarbonates), of di- or polycarboxylic acids and diamines/imines (polycarboxylic acid amides/imides), of sulfones (polysulfones), of di- or polycarboxylic acids and di- or polyols (polyesters), of halogenated, particularly of fluorinated compounds as well as phenol/formaldehyde condensation products, polyacetals, phenol resins, amine resins.

10. The sound-absorbing coating for an elastic structure (1) according to claim 1, comprising, as the coating layer (2) closer to the elastic structure (1) a layer made of the polymer A selected from the group consisting of homopolymers, copolymers and/or blends of homopolymers and/or copolymers of acrylic acid, of methacrylic acid, of alkyl esters of acrylic acid and of alkyl esters of methacrylic acid as well as rubbers or their blends with each other and with others of the above-mentioned polymers and/or, as the coating layer (3) farther from the elastic structure and immediately applied onto the polymer A, a layer made of the polymer B selected from the group consisting of epoxy resins, amine resins (in particular melamine resins and/or urethane resins) and their blends.

11. The sound-absorbing coating for an elastic structure (1) according to claim 10, wherein the thickness of the layer made of the polymer A is in the range of from 0.1 to 10 mm, preferably in the range of from 0.5 to 5 mm, and/or the thickness of the layer made of the polymer B is in the range of from 0.01 to 3 mm, preferably in the range of from 0.01 to 1 mm.

12. A process for the application of a sound-absorbing coating according to claim 1 onto an elastic structure (1), said process comprising the steps of
optionally providing the elastic structure (1) with a base coat;
applying at least one coating layer (2) made of at least one polymer A on said optionally provided base coat or on the elastic structure (1);
optionally curing said coating layer(s) (2) thus applied completely or in part;
applying at least one coating layer (3) made of at least one polymer B on said layer(s) (2) thus applied and optionally cured; and
completely curing said layer(s) thus applied.

13. The process according to claim 12, wherein the application of (optionally) base coat, layer(s) (2) and/or layer(s) (3) is effected by spraying, rolling, dipping, applying by extruding or a combination of two or more of the above methods.

14. The process according to claim 12, wherein at least one of the steps
optionally applying the base coat;
applying at least one layer (2) of at least one polymer A;
applying at least one layer (3) of at least one polymer B;
is effected by spraying, preferably by spraying by means of an automated spraying device, or by applying by means of a slot die.

15. The process according to claim 12, wherein at least one of the coating layers of the sound-absorbing coating, preferably all coating layers of the sound-absorbing coating, is are applied in the form of a solution, emulsion, mixture or melt comprising the components for forming the coating layers(s).

16. The process according to claim 12, wherein at least one of the coating layers of the sound-absorbing coating, preferably all coating layers of the sound-absorbing coating, is are applied in the form of the neat liquid monomers containing all components for a reaction of the monomers with each other with polymerization.

17. The process according to claim 12, wherein the curing or initiation of the polymerization reaction is effected by heat, actinic radiation or microwave treatment or by a combination of two or more of the above methods.

18. The process according to claim 12, wherein the polymer A is applied by depositing and the polymer B is applied by extruding by means of a slot die.

19. A 1 method for forming a sound-absorbing coating on partial structures of tools or their housings, on machines and their housings, on housings of devices having moving mechanical parts or on structures of automotive vehicles wherein the coating is a sound-absorbing coating according to claim 1.

20. The method of claim 19 for forming a sound-absorbing coating on automotive vehicle structures, preferably on vehicle body part surfaces, and/or on walls serving for sound absorption.
